(19) United States
(12) Patent Application Publication
(10) Pub. No.: US 2022/0025257 A1
(43) Pub. Date: Jan. 27, 2022

(54) TERNARY TRANSITION METAL HALIDE SCINTILLATORS

(71) Applicants: Luis Stand Stracuzzi, Knoxville, TN (US); Mao-Hua Du, Knoxville, TN (US); Edgar V. Van Loef, Watertown, MA (US); Merry A. Koschan, Knoxville, TN (US); Mariya Zhuravleva, Knoxville, TN (US); Charles L. Melcher, Oak Ridge, TN (US); Kanai S. Shah, Watertown, MA (US)

(72) Inventors: Luis Stand Stracuzzi, Knoxville, TN (US); Mao-Hua Du, Knoxville, TN (US); Edgar V. Van Loef, Watertown, MA (US); Merry A. Koschan, Knoxville, TN (US); Mariya Zhuravleva, Knoxville, TN (US); Charles L. Melcher, Oak Ridge, TN (US); Kanai S. Shah, Watertown, MA (US)

(21) Appl. No.: 17/240,344

(22) Filed: Apr. 26, 2021

Related U.S. Application Data
(60) Provisional application No. 63/015,189, filed on Apr. 24, 2020.

(51) Int. Cl. C09K 11/61; C09K 11/62; C09K 11/77; G01T 1/20

(52) U.S. Cl. CPC C09K 11/616; G01T 1/2018; C09K 11/7733; C09K 11/62

(57) ABSTRACT

Ternary transition metal halides are described herein. The ternary transition metal halides may be used as scintillator materials.

### RELATED APPLICATIONS

This application claims priority to U.S. Provisional Patent Application Ser. No. 63/015,189, filed on Apr. 24, 2020, which is incorporated herein by reference in its entirety.

### GOVERNMENT INTEREST

The United States Government has rights in this invention pursuant to contract no. DE-AC05-000R22725 between the United States Department of Energy and UT-Battelle, LLC. In addition, this invention was made with government support under contract HDTRA1-19-1-0014 awarded by the Department of Defense. The government has certain rights in the invention.

### BACKGROUND

Scintillator materials, which emit light pulses in response to impinging radiation, such as X-rays, gamma rays, and thermal neutron radiation, are used in detectors that have a wide range of applications in medical imaging, particle physics, geological exploration, security and other related areas. Considerations in selecting scintillator materials typically include, but are not limited to, luminosity, decay time, energy resolution, and emission wavelength.

While a variety of scintillator materials have been developed, there is an ongoing need to develop additional scintillator materials with improved properties for particular applications.

### SUMMARY

Ternary metal halide scintillator materials (e.g., containing Zn or Cu or other transition metals) are described herein. For example, single crystals of several compounds were grown as described herein via directional solidification of ˜5 gram molten charges sealed in evacuated 7 mm diameter quartz ampoules in a vertical Bridgman configuration. Growth rates ranged from 0.1 to 2 mm/hr, and cool down rates were ˜10° C./hr. Samples of ˜100 mm³ were prepared for scintillation measurements.

As described hereinbelow, several members of the AₐM_{b}X_{c} family (where the a-b-c formula units are 3-1-5, 1-2-5, 3-2-5, 2-1-3, or 2-1-4, and X is one or more halogens) were studied as potential single crystal scintillators with high density and high atomic number for gamma spectroscopy. Melting points ranged from 530 to 601° C. for the congruently melting Cs compounds; densities ranged from 3.35 to 4.3 g/cm³; and effective atomic numbers ranged from 38 to 53. Partial or full replacement of Cs with Tl further increases the densities and effective atomic numbers and lowers the melting points. X-ray diffraction was used to study crystal structures. The quasi-0D structure of Cs₃ZnX₅ contains isolated ZnX₄ tetrahedra that can act as luminescent centers by localizing excitons. Emission apparently from self-trapped excitons was observed from undoped samples under X-ray irradiation, while samples with Eu²⁺ activation displayed lower emission intensity and apparent activator segregation. Activation with Cu⁺ resulted in a broad emission centered at ˜450 nm. AₐM_{b}X_{c} compounds where A is Cs, M is Cu, and X is I showed particularly intense scintillation emission. Activation with luminescent ions, both isovalent and aliovalent, is also expected to provide strong emission and good energy resolution.

Partial replacement of Cs with Li provided for neutron detection and discrimination of neutron from gamma radiation.

Certain scintillators of the presently disclosed subject matter can be described by the general formulas below.
A₂MX₃ where, A=Cs, Rb, Na, Tl, Li, B; M=Cu, Ag and X=Halogen
AM₂X₃ where A=Cs, Rb, Na, Tl, Li, B; M=Cu, Ag, and X=Halogen
A₃M₂X₅ where A=Cs, Rb, Na, Tl, Li, B; M=Cu, Ag, and X=Halogen
A₂MX₄ where A=Cs, Rb, Na, Li, Tl, B; M=Zn, Hg, Cu, Cd, and X=Halogen
A₃MX₅ where A=Cs, Rb, Na, Li, Tl, B; M=Zn, Hg, Cu, Cd and X=Halogen
AM₂X₅ where A=Cs, Rb, Na, Li, Tl, Cu, B; M=Zn, Hg, Cd, Cu, X=Halogen
A_{1-y}M_{y}X where A=Cs, Rb, Na, Tl, Li, B; M=Cu, Ag and X=Halogen

Luminescence activators (also referred to as dopants) such as Au, Cu, Tl, In, Sn Yb, Eu, Ce, and Pr can substitute the A site or M site, and they can substitute from 0 mol % to 100 mol %. In some embodiments, a luminescent activator substitutes at least 0.0001 mol % of an A site or a M site.

### BRIEF DESCRIPTION OF THE DRAWINGS

FIG. 1. (Left) Crack free, 7 mm diameter single crystals of undoped Cs₃Cu₂I₅ and (Right) Tl-doped Cs₃Cu₂I₅. At the top, under white light and at the bottom under UV light.

FIG. 2. DSC curve of Cs₃Cu₂I₅.

FIG. 3. Cs₃Cu₂I₅ powder x-ray diffraction pattern matched to reference pattern.

FIG. 4A. Photoluminescence emission/excitation of undoped Cs₃Cu₂I₅ showing defect mediated luminescence.

FIG. 4B. PL decay time curve of undoped Cs₃Cu₂I₅ fitted with a single component exponential function with a time constant of 1040 ns.

FIG. 4C. RL spectra of undoped Cs₃Cu₂I₅ showing a broad emission centered at 440 nm.

FIG. 4D. Scintillation decay curve fitted with three-component exponential function with time constants of 60 ns (1%), 310 ns (7%), 1050 ns (92%).

FIG. 5A. PL emission/excitation of Tl-doped Cs₃Cu₂I₅, showing the undoped emission at 440 nm, and Tl-doped Cs₃Cu₂I₅ emission at 495 nm were observed in Tl-doped crystals.

FIG. 5B. PL decay time curve of Cs₃Cu₂I₅(Tl 05%) fitted with a single component exponential function with a time constant of 1000 ns for the 440 nm emission and 720 ns for the 495 nm emission.

FIG. 5C. RL spectra of Cs₃Cu₂I₅(Tl 0.5%) showing a broad emission centered at 500 nm.

FIG. 5D. Scintillation decay curve fitted with a single component exponential function with a time constant of 840 ns.

FIGS. 6A-6B. ¹³⁷Cs spectra of (FIG. 6B) undoped Cs₃Cu₂I₅ and (FIG. 6A) Cs₃Cu₂I₅(Tl 0.5%).

FIG. 7. Non-proportional response of undoped Cs₃Cu₂I₅ (circles) and Cs₃Cu₂I₅(Tl 0.5%) (squares).

FIG. 8. Small crystals of undoped Cs₃ZnBr₅ (left) and Cs₃ZnI₅ (right).

FIG. 9. Excellent quality 7 mm diameter single crystals of Eu-doped Cs₂ZnCl₄, Cs₂ZnBr₄, and Cs₂ZnI₄

FIG. 10. Excellent quality 7 mm diameter single crystals of Eu-doped Cs₃ZnCl₅, and Cs₃ZnBr₅,

FIG. 11. Melt samples of various composition under UV light excitation.

FIG. 12. Melt samples of Li₂ZnI₄(Eu 0.5%) and Li₃ZnI₅(Eu 0.5%) under UV light excitation

FIGS. 13A-13D. X-ray excited emission of single crystals of (FIG. 13A) Cs₂ZnCl₄:Eu 0.5%, (FIG. 13B) Cs₂ZnBr₄:Eu 0.5%, (FIG. 13C) Cs₂ZnBr₂I₂:Eu 0.5% and (FIG. 13D) Cs₂ZnI₄:Eu 0.5%.

FIGS. 14A-14D. X-ray excited emission of single crystals of (FIG. 14A) Cs₃ZnCl₅:Eu 0.5%, (FIG. 14B) Cs₃ZnBr₅:Eu 0.5%, (FIG. 14C) Cs₃ZnI₅:Eu 0.5%—melt sample and (FIG. 14D) Li₃ZnI₅:Eu 0.5%—melt sample.

FIG. 15. X-ray excited emission of Cs₃ZnI₅:Cu 0.5%—melt sample.

FIG. 16. X-ray excited emission of CsZn₂I₅:Eu 0.5%—melt sample.

FIGS. 17A-17B. X-ray excited emission (FIG. 17A) and pulse shape discrimination (FIG. 17B) of single crystals of (Cs_{0.8}Li_{0.2})₃Cu₂I₅:Tl.

FIG. 18. Excellent quality 16 mm diameter single crystals of Tl-doped CS₃CU₂I₅.

FIGS. 19A-19D. Scintillation properties of Cs₃Cu₂I₅: 0.2% Tl: Emission (FIG. 19A); Energy Resolution (FIG. 19B); Non-proportionality (FIG. 19C); and Light Yield (FIG. 19D)

FIGS. 20A-20E. Crystal growth of Cs₃Cu₂I₅: 0.05% Tl (FIG. 20A); Cs₃Cu₂I₅: 0.1% Tl (FIG. 20B); Cs₃Cu₂I₅: 0.5% Tl (FIG. 20C); Cs₃Cu₂I₅: 0.1% Tl (FIG. 20D); Cs₃Cu₂I₅: 3% Tl (FIG. 20E)

FIGS. 21A-21E. Gamma response of Cs₃Cu₂I₅: 0.1% Tl (FIG. 21A); Cs₃Cu₂I₅: 1% Tl (FIG. 21B); Cs₃Cu₂I₅: 0.05% Tl (FIG. 21C); Cs₃Cu₂I₅: 0.5% Tl (FIG. 21D); Cs₃Cu₂I₅: 3% Tl (FIG. 21E)

FIGS. 22A-22C. Scintillation properties of Cs₃Cu₂I₅: X % Tl: Decay time (FIG. 22A); X-ray excited emission (FIG. 22B); Non-proportionality (FIG. 22C) FIG. 23. Excellent quality 1 inch diameter single crystal of undoped Cs₃Cu₂I₅.

FIGS. 24A-24B. Excellent quality (crack free) co-doped Cs₃Cu₂I₅ crystals: from left to right: Cs₃Cu₂I₅(Y 0.5%), Cs₃Cu₂I₅(In 2%), Cs₃Cu₂I₅(Ce 2%), Cs₃Cu₂I₅(Sr 1%), Cs₃Cu₂I₅(Yb 1%), Cs₃Cu₂I₅(Hf 1%), Cs₃Cu₂I₅(Eu 2%) Cs₃Cu₂I₅(Ce 2%), Cs₃Cu₂I₅(Ca 0.5%)

### DETAILED DESCRIPTION

The presently disclosed subject matter will now be described more fully. The presently disclosed subject matter can, however, be embodied in different forms and should not be construed as limited to the embodiments set forth herein below and in the accompanying Examples. Rather, these embodiments are provided so that this disclosure will be thorough and complete, and will fully convey the scope of the embodiments to those skilled in the art.

All references listed herein, including but not limited to all patents, patent applications and publications thereof, and scientific journal articles, are incorporated herein by reference in their entireties to the extent that they supplement, explain, provide a background for, or teach methodology, techniques, and/or compositions employed herein.

### I. DEFINITIONS

While the following terms are believed to be well understood by one of ordinary skill in the art, the following definitions are set forth to facilitate explanation of the presently disclosed subject matter.

Unless defined otherwise, all technical and scientific terms used herein have the same meaning as commonly understood to one of ordinary skill in the art to which the presently disclosed subject matter belongs.

Following long-standing patent law convention, the terms “a”, “an”, and “the” refer to “one or more” when used in this application, including the claims.

The term “and/or” when used in describing two or more items or conditions, refers to situations where all named items or conditions are present or applicable, or to situations wherein only one (or less than all) of the items or conditions is present or applicable.

The use of the term “or” in the claims is used to mean “and/or” unless explicitly indicated to refer to alternatives only or the alternatives are mutually exclusive, although the disclosure supports a definition that refers to only alternatives and “and/or.” As used herein “another” can mean at least a second or more.

The term “comprising”, which is synonymous with “including,” “containing,” or “characterized by” is inclusive or open-ended and does not exclude additional, unrecited elements or method steps. “Comprising” is a term of art used in claim language which means that the named elements are essential, but other elements can be added and still form a construct within the scope of the claim.

As used herein, the phrase “consisting of” excludes any element, step, or ingredient not specified in the claim. When the phrase “consists of” appears in a clause of the body of a claim, rather than immediately following the preamble, it limits only the element set forth in that clause; other elements are not excluded from the claim as a whole.

As used herein, the phrase “consisting essentially of” limits the scope of a claim to the specified materials or steps, plus those that do not materially affect the basic and novel characteristic(s) of the claimed subject matter.

With respect to the terms “comprising”, “consisting of”, and “consisting essentially of”, where one of these three terms is used herein, the presently disclosed and claimed subject matter can include the use of either of the other two terms.

Unless otherwise indicated, all numbers expressing quantities of time, temperature, light output, atomic (at) or mole (mol) percentage (%), and so forth used in the specification and claims are to be understood as being modified in all instances by the term “about”. Accordingly, unless indicated to the contrary, the numerical parameters set forth in this specification and attached claims are approximations that can vary depending upon the desired properties sought to be obtained by the presently disclosed subject matter.

As used herein, the term “about”, when referring to a value is meant to encompass variations of in one example ±20% or ±10%, in another example ±5%, in another example ±1%, and in still another example ±0.1% from the specified amount, as such variations are appropriate to perform the disclosed methods.

The term “scintillator” refers to a material that emits light (e.g., visible light) in response to stimulation by high energy radiation (e.g., X, α, β, or γ radiation). In some embodiments, the high energy radiation is a thermal neutron.

The term “phosphor” as used herein refers to a material that emits light (e.g., visible light) in response to irradiation with electromagnetic or particle radiation.

In some embodiments, the compositional formula expression of an optical material (e.g., a scintillation material or a phosphor) can contain a colon “:” or comma, wherein the composition of the main or base matrix material (e.g., the main ternary transition metal halide matrix) is indicated on the left side of the colon or comma, and an activator (or dopant ion) or an activator and a codopant ion are indicated on the right side of the colon or comma. In some embodiments, the dopant and codopant can replace all or part of metal A or the metal M or M′ in one of the formula described herein.

The term “high energy radiation” can refer to electromagnetic radiation having energy higher than that of ultraviolet radiation, including, but not limited to X radiation (i.e., X-ray radiation), alpha (α) particles, neutrons, gamma (γ) radiation, and beta (β) radiation. In some embodiments, the high energy radiation refers to gamma rays, cosmic rays, X-rays, and/or particles having an energy of 1 keV or greater. Scintillator materials as described herein can be used as components of radiation detectors in apparatuses such as counters, image intensifiers, and computed tomography (CT) scanners.

“Optical coupling” as used herein refers to a physical coupling between a scintillator and a photosensor, e.g., via the presence of optical grease or another optical coupling compound (or index matching compound) that bridges the gap between the scintillator and the photosensor. In addition to optical grease, optical coupling compounds can include, for example, liquids, oils and gels.

“Light output” can refer to the number of light photons produced per unit energy deposited, e.g., by a gamma ray being absorbed, typically the number of light photons/MeV.

As used herein, chemical ions can be represented simply by their chemical element symbols alone (e.g., Pr for praseodymium ion(s) (e.g., Pr³⁺) or Cu for copper ion(s) (e.g., Cu⁺ or Cu²⁺)). Similarly, the term “transition metal element” is used herein to refer to a transition metal element ion or a combination of transition metal element ions.

The term “rare earth element” as used herein refers to one or more elements selected from a lanthanide (e.g., lanthanum (La), cerium (Ce), Praseodymium (Pr), neodymium (Nd), promethium (Pm), samarium (Sm), europium (Eu), gadolinium (Gd), terbium (Tb), dysprosium (Dy), holmium (Ho) erbium (Er), thulium (Tm), ytterbium (Yb) and lutetium (Lu)), scandium (Sc), and yttrium (Y).

The term “transition metal element” as used herein refers to one or more elements selected from titanium (Ti), vanadium (V), chromium (Cr), manganese (Mn), iron (Fe), cobalt (Co), nickel (Ni), copper (Cu), zinc (Zn), zirconium (Zr), niobium (Nb), molybdenum (Mo), technetium (Tc), ruthenium (Ru), rhodium (Rh), palladium (Pd), silver (Ag), cadmium (Cd), hafnium (Hf), tantalum (Ta), tungsten (W), rhenium (Re), osmium (Os), iridium (Ir), platinum (Pt), gold (Au), mercury (Hg), rutherfordium (Rf), dubnium (Db), seborgium (Sg), bohrium (Bh), hassium (Hs), meitnerium (Mt), darmstadtium (Ds), roentgenium (Rg), and copernicium (Cn).

The term “halogen” as used herein refers to one or more elements selected from fluorine (F), chlorine (CI), bromine (Br), and iodine (I).

### II. DESCRIPTION

As noted above, ternary transition metal halides are described herein. The ternary transition metal halides may be used as scintillator materials. Such materials (e.g., Cs₃Cu₂I₅) have been shown to have particularly attractive scintillation properties and may be used in a variety of applications for detecting radiation (e.g., thermal neutrons and/or gamma rays).

In some embodiments, the ternary transition metal halides may have a composition of one of Formulas (I)-(VII):

A₂MX₃; (I)

AM₂X₃; (II)

A₃M₂X₅; (III)

A₂M′X₄; (IV)

A₃M′X₅; (V)

AM₂X₅; or (VI)

A_{1-y}M_{y}X; (VII)

In some embodiments, A₃M₂X₅ or A₃M₂X₅ may be preferred Formulas.

In some embodiments, X comprises one or more halogen. The halogen may be fluorine (F), chlorine (CI), bromine (Br) and iodine (I).

In some embodiments, A comprises one or more elements selected from the group comprising Li, Na, Rb, B, Cs, and Tl. In some embodiments, it may be preferred for A to comprise Cs. In some embodiments, A may be more than one element. For example, A may comprise Cs and may further comprise Li, B or Na. In some embodiments, it may be preferred for A to comprise Cs and to further comprise Li (e.g., between 10 mol % and 50 mol %). In cases, where Li is present, Li may be (entirely or partially) in the form of ⁶Li. In some cases, the lithium content of the composition is enriched to include a Li-6 content above that which is found in naturally occurring lithium sources. It should be understood, however, that not all compositions of the invention are enriched.

In some embodiments, M is Cu, Ag, or a combination thereof. In some embodiments, it may be preferred for M to comprise Cu.

In some embodiments, M′ is one or more elements selected from the group comprising Zn, Hg, Cu, and Cd. In some embodiments, it may be preferred for M′ to comprise Zn and/or Cu.

In general, y may have any suitable number in Formula (VII). For example, y may be between 0.0001 and 0.9999; between 0.1 and 0.9; or between 0.1 and 0.5, amongst other values.

In some embodiments, it may be preferred for A to comprise Cs, M to comprise Cu and X to comprise I. For example, in some such embodiments, it may be preferred for the composition to be Cs₃Cu₂I₅ (which may or may not include one or more further dopants). Such compositions have been demonstrated to have particularly excellent scintillation properties and characteristics, e.g., as shown in certain examples and data including herein. In some embodiments, certain Cs—Zn based halide compositions may be preferred including Cs₂ZnCl₄, Cs₂ZnBr₄, Cs₂ZnI₄, Cs₃ZnCl₅, Cs₃ZnBr₅ and Cs₃ZnI₅.

In some embodiments, e.g., when the scintillator material comprises a composition of Formula (III) and M is Cu and A comprises Cs, A further comprises Li, B, or Na, and when the scintillator material is a composition of Formula (II), the scintillator material has a composition that is other than CsCu₂I₃. In some embodiments, the scintillator material is not Cs₃Cu₂[I₁₋ₓClₓ]₅, e.g., wherein 0.71≤x≤0.79.

In the compositions described herein, it should be understood that one or more luminescence activators, L, (also referred to herein as dopants) may replace 0 mole percent (mol %) to 100 mol % of A and/or M or M′ in the above-described compositions. L may be an isovalent or aliovalent luminescent ion of an element selected from Au, Cu, Tl, In, Sn, Yb, Eu, Ce, and Pr or a combination thereof. In some cases, Tl and/or Eu are preferred dopants. In some cases, the mole percent of dopants in the composition may be at least 0.5 mol %; in some cases, between 0-25 mol %; in some cases, between 0-10 mol %; and, in some cases, between 0-5 mol %.

The disclosed compositions may be prepared in any number of different forms. In some embodiments, the composition is in a crystalline form (e.g., single crystal).

Methods for making the disclosed compositions can include the methods described herein or any other appropriate technique. Typically during the manufacture of many types of scintillator compositions, the appropriate reactants are melted at a temperature sufficient to form a congruent, molten composition. The melting temperature depends on the identity of the reactants themselves (e.g., melting points of reactants), but is usually in the range of about 300° C. to about 1350° C. Non-limiting examples of possible crystal-growing methods include the Bridgman-Stockbarger method (e.g., vertical Bridgman); Czochralski growth method, zone-melting growth method (or “floating zone” method), the vertical gradient freeze (VGF) method, and the temperature gradient method.

Following formation of the compositions, crystals may be processed using techniques and methods known to those of ordinary skill in the art. Such processes include cutting, polishing, and/or packaging (e.g., under an inert atmosphere). In addition, the compositions may be analyzed using methods and techniques known to those of ordinary skill in the art to determine the compositional make-up of the compositions, for example, using differential scanning calorimetry (DSC) and/or crystal structure (XRD).

As noted, the scintillator material compositions described herein may be used in detectors. The detector may be used to radiation (e.g., gamma rays, x-rays, cosmic rays and/or particles having an energy of 1 keV or greater). The detector may include one or more scintillators optically coupled to a light detector assembly, such as a light photodetector, or imaging device, or other appropriate light sensitive detector. The detector assembly may include a data analysis system to process information from the scintillator and light sensitive detector. Non-limiting examples of a light detector assembly include photomultiplier tubes (PMT), photodiodes, CCD sensors, image intensifiers, and the like. Choice of a particular light detector assembly will depend in part on the type of radiation detector being fabricated and on its intended use of the device. In certain embodiments, the photodetector may be position-sensitive. In use, the detector detects energetic radiation emitted from a source.

The detector assemblies themselves, which may include the scintillator material and the light detector assembly, may be connected to a variety of tools and devices. Non-limiting examples include monitoring and detection devices, well-logging tools, and imaging devices such as X-ray CT, X-ray fluoroscopy, X-ray cameras (such as for security uses), PET, and other nuclear medical imaging or detection devices. The above examples are merely illustrative of the types of application the current composition may be used for and should not be interpreted to limit the use of the present material in other appropriate applications. Various technologies for operably coupling or integrating a radiation detector assembly containing a scintillator to a detection device may be utilized.

A data analysis system may be coupled to the detector. The data analysis system may include, for example, a module or system to process information (e.g., radiation detection information) from the detector/light detector assembly. The data analysis system may also include, for example, a wide variety of proprietary or commercially available computers, electronics, systems having one or more processing structures, or the like. The systems may have data processing hardware and/or software configured to implement any one (or combination of) the method steps described herein. The methods may further be embodied as programming instructions in a tangible non-transitory media such as a memory, a digital or optical recording media, or other appropriate device.

### III. EXAMPLES

The following examples are included to further illustrate various embodiments of the presently disclosed subject matter. However, those of ordinary skill in the art should, in light of the present disclosure, appreciate that many changes can be made in the specific embodiments which are disclosed and still obtain a like or similar result without departing from the spirit and scope of the presently disclosed subject matter.

Crystal Growth

Single crystals of copper and zinc containing halides were grown via the vertical Bridgman technique. Due to the hygroscopic nature of the reactants and products of these experiments, handling took place inside an ultra-dry Mbraun glovebox with <0.01 ppm H₂O and O₂. Anhydrous raw materials of at least 99% purity were mixed and loaded into quartz ampoules in stoichiometric amounts. The loaded ampoules were dried using temperatures ranging from 100 to 250° C. The ampoules were sealed using H₂—O₂ torch under a dynamic vacuum of at least 10⁻⁵ torr. Prior to the crystal growth experiments, a mixing step was carried out by melting the raw materials for 72 hours and then cooling to room temperature over a 10-hour period.

General Methods

The melting and crystallization temperatures of ˜30 mg samples were measured using a Seteram Labsys Evo differential scanning calorimetry (DSC) instrument. The Powder x-ray diffraction (PXRD) were measured using a PANalytical Empyrean 2-theta Diffractometer. Scans were collected from 10 to 70° 2-theta with a step size of 0.0131°. The measured PXRD pattern was matched using GSAS-II, an open-source software package to verify that the desired phase was grown.

The radioluminescence (RL) measurements were done under continuous 30 keV X-ray irradiation using a CMX003 X-ray generator. The emission spectra were recorded in reflection mode with a 150-mm focal length monochromator over a 200 to 800 nm wavelength range. The steady state photoluminescence (PL) spectra were measured with a Horiba Jobin Yvon Fluorolog 3 Spectrofluorometer equipped with a Xe lamp and dual scanning monochromators. The PL lifetimes were measured using the time correlated single photon counting technique. The excitation sources were 1 ns pulse width NanoLeds with emission wavelengths ranging from 260 nm to 370 nm. The emission monochromator wavelength was set to monitor emissions of the activator studied.

The pulse height spectra of a standard set of γ-ray sealed sources (¹³⁷Cs, ²²Na, ¹³³Ba, ⁵⁷Co and ²⁴¹Am) were collected using a standard bialkali Hamamatsu R2059 photomultiplier tube (PMT) or super bialkali R6231-100 PMT connected to regular NIM electronics. Several layers of Teflon tape and a hemispherical dome of Spectralon were used as reflectors. A shaping time of 10 μs was used to ensure complete light collection. The absolute light yield in photons per MeV (ph/MeV) was measured via the single photoelectron technique using a factory measured quantum efficiency R2059 PMT. The energy resolution and the non-proportionality (nPR) of the crystals were measured using the R6231-100 PMT. The energy resolution was defined as the Full Width Half Maximum over the centroid of the photopeak of energy E (R=ΔE(FWHM)/E). The nPR or relative light yield was defined as the ratio between centroid position of a photopeak of energy E and centroid position at 662 keV. The scintillation decay time was measured using a time-correlated single photon counting technique under ¹³⁷Cs excitation). The time constants were obtained by fitting a multicomponent exponential function to the decay curves.

Crystal Growth Cu-Containing Halides

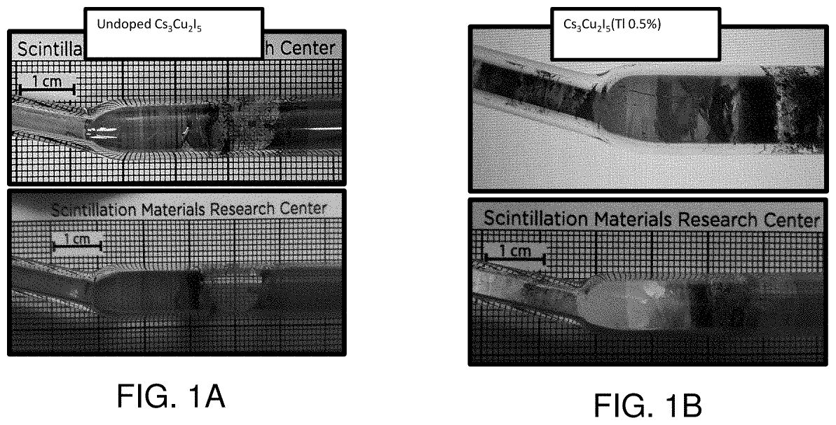

Single crystals of undoped Cs₃Cu₂I₅ and Cs₃Cu₂I₅ doped with 0.5 mol % Tl⁺ were grown via the vertical Bridgman technique. The crystal growth experiments were carried out in a two-zone transparent furnace in which a one-inch thick diaphragm was placed between the hot zone and cool zone to achieve an 18° C./cm thermal gradient at the growth interface. The self-seeding process took place at 3 mm diameter grain selector connected to the bottom of the ampoule. All the boules were grown using a pulling rate 0.35 mm/h and cooled down to room temperature in 70 hours. The result were highly transparent single crystals, as show in FIG. 1.

DSC and Phase Verification

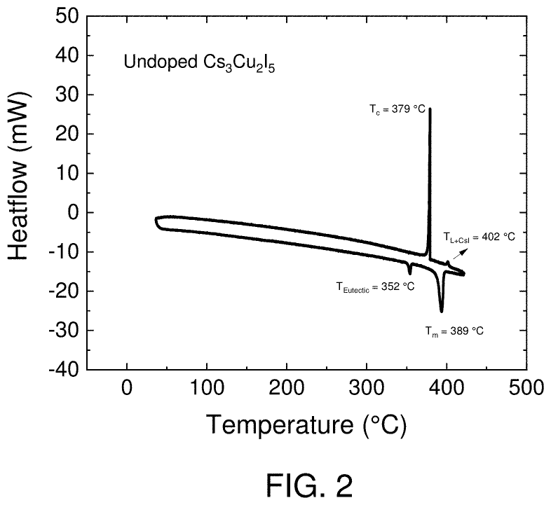

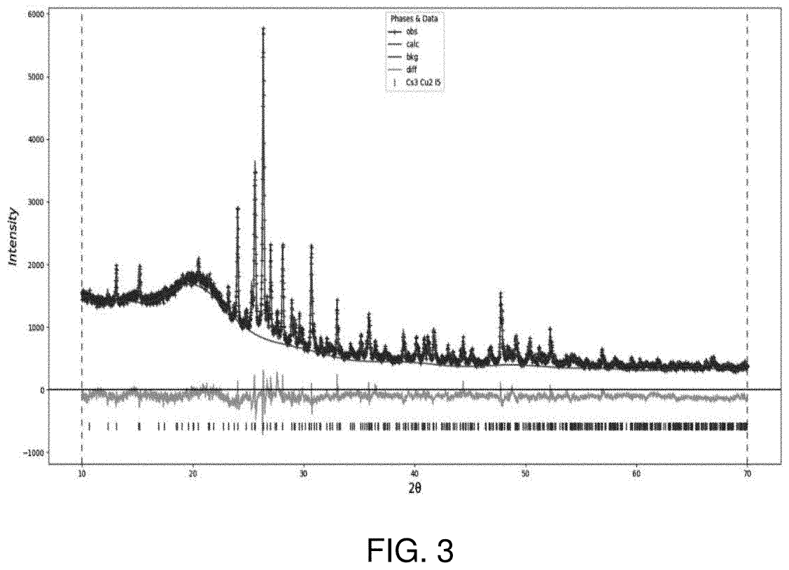

The DSC curve Cs₃Cu₂I₅ has multiple endothermic and exothermic peaks which suggest its peritectic nature, as shown in FIG. 2. The peak at 352° C. corresponds to the CsCu₂I₃—Cs₃Cu₂I₅ eutectic melting point and the peak at 389° C. correspond to the melting point of Cs₃Cu₂I₅. The observed melt behavior does impact the crystal quality of Cs₃Cu₂I₅, as all the foreign phases, including the CsCu₂I₃—Cs₃Cu₂I₅ eutectic, are segregated to the last to freeze section of the boule. Cs₃Cu₂I₅ was a single phase, without any precursor or CsCu₂I₃—Cs₃Cu₂I₅ impurities. The PXRD pattern was matched and refined to the structure published by Hull et al. (J. Solid State Chemistry (2004), 177, 3156-3173), as shown in FIG. 3.

Optical and Scintillation Properties of Cu-Containing Halides

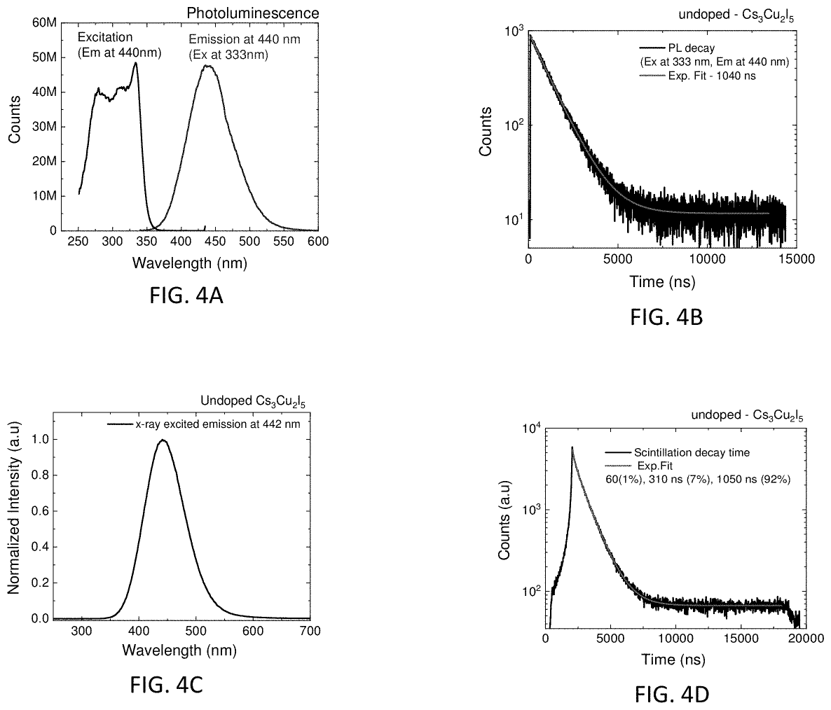

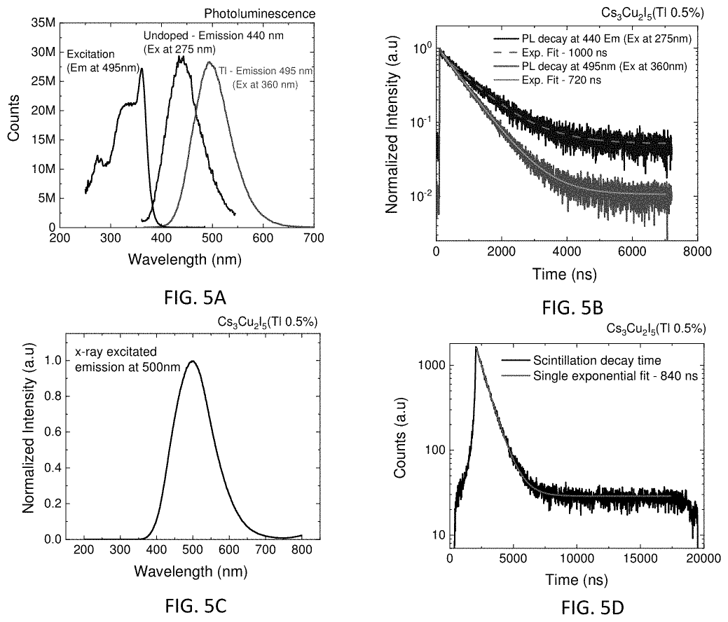

The photoluminescence emission/excitation and the x ray excited emission spectrums are shown in FIGS. 4A, 4C, 5A, and 5C. These results suggest the luminescence observed in undoped Cs₃Cu₂I₅ is related to a defect mediated transition, e.g., self-trapped excitons, self-trapped holes, etc. The luminescence and scintillation process of Tl-doped Cs₃Cu₂I₅ is unclear and it needs to be further investigated. However, it is likely to be similar to either NaI(Tl) or CsI(Tl). The PL decay and scintillation decay times of undoped Cs₃Cu₂I₅ and Tl-doped Cs₃Cu₂I₅ are between 700-1000 ns, as shown in FIGS. 4B, 4D, 5B, and 5D.

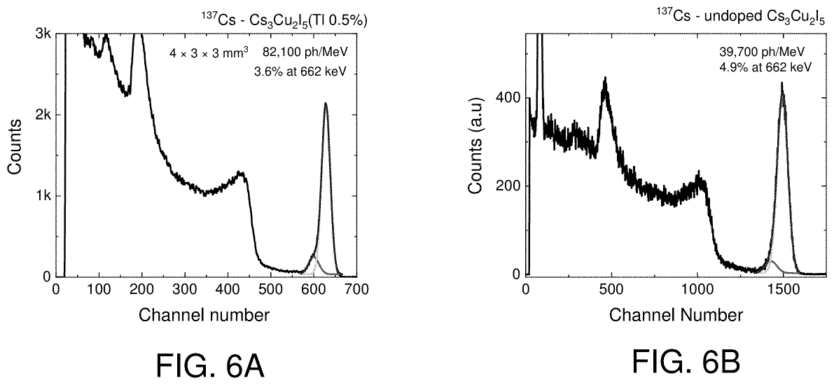

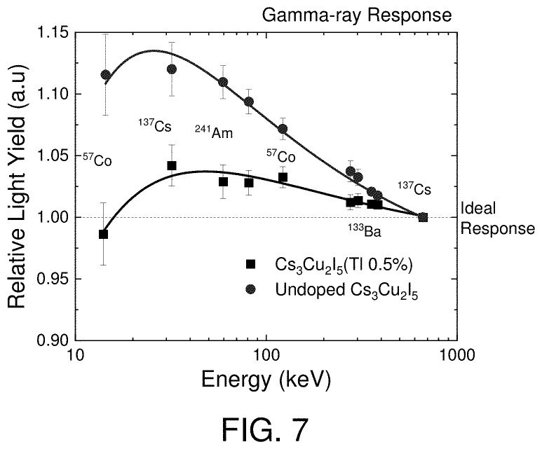

The ¹³⁷Cs spectra of undoped Cs₃Cu₂I₅ and Cs₃Cu₂I₅(Tl 0.5%) are shown in FIGS. 6A and 6B. Undoped Cs₃Cu₂I₅ had 37,700 ph/MeV and 4.9% energy resolution at 662 keV, while Cs₃Cu₂I₅(Tl 0.5%) had an impressive light yield of 82,100 ph/MeV with an energy resolution of 3.6% at 662 keV. The non-proportionality of both crystals features a “halide hump” at intermediate energies. See FIG. 7. The undoped crystal has a deviation from ideal that is similar to NaI(Tl) while the Tl-doped has flatter response similar to other high performance scintillators such as Eu²⁺-doped KSr₂I₅ and Cs₄SrI₆.

Crystal Growth Zn-Containing Halides

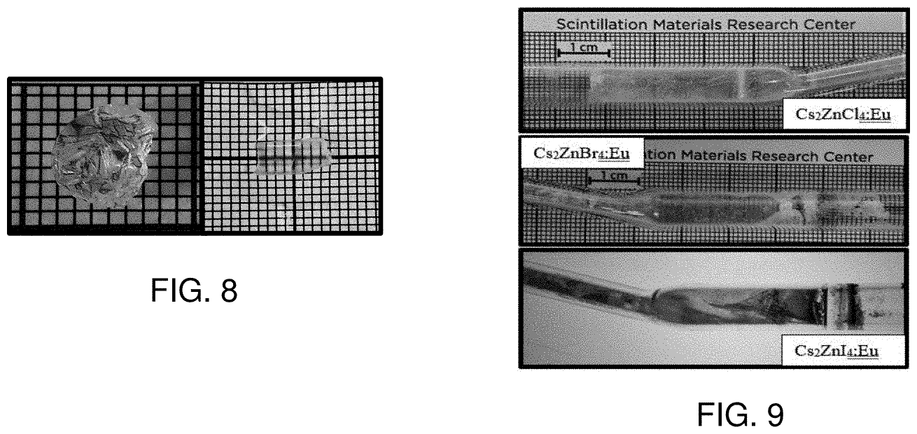

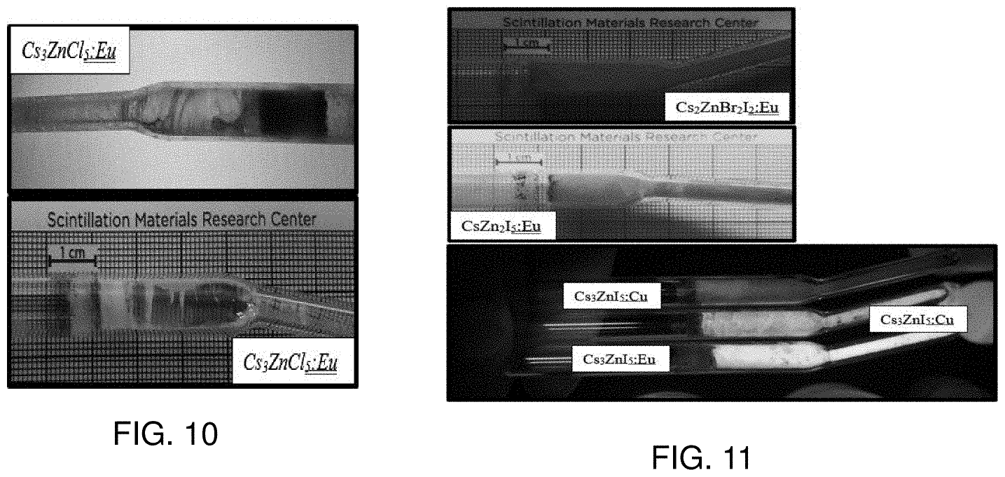

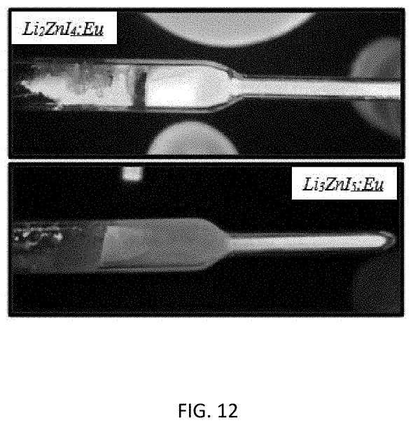

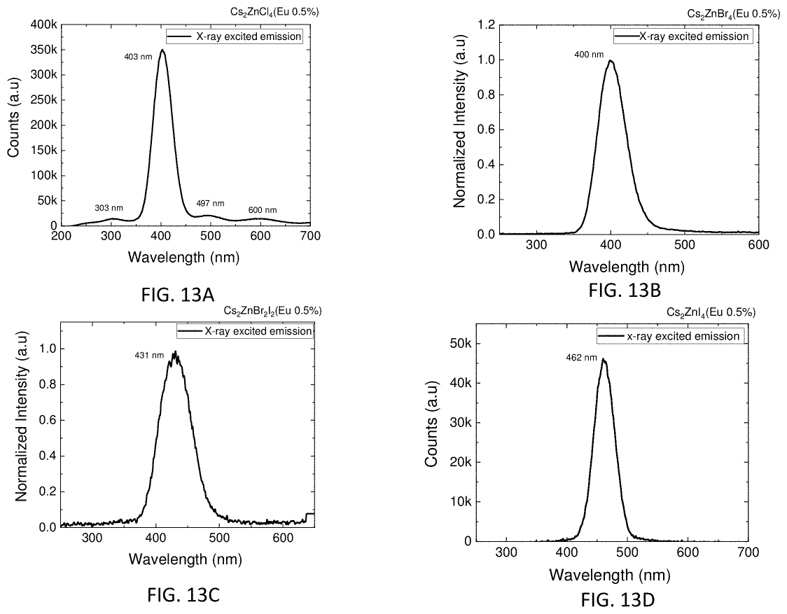

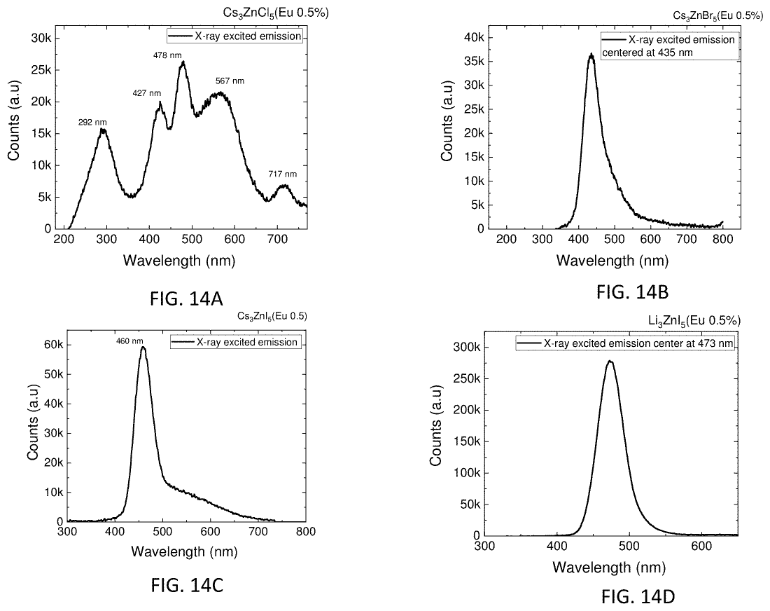

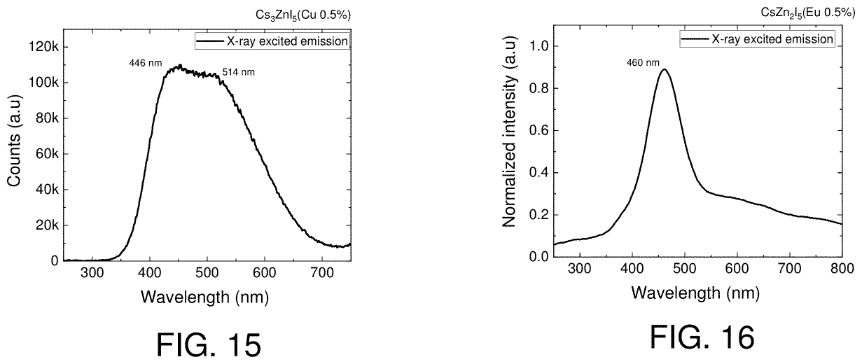

Single crystals of undoped and Eu-doped ternary and quaternary Zn-containing halide crystals were grown via the vertical Bridgman technique. The growth experiments were carried out in a two-zone furnace in which a one-inch thick diaphragm was placed between the hot zone and cool zone to achieve the desired thermal gradient thermal at the growth interface. The self-seeding process took place at 2- or 4-mm diameter grain selector connected to the bottom of the ampoule. All the boules were grown using a pulling rate of 0.4 mm/h and cooled down to room temperature in 70 hours. Exemplary Zn-containing scintillator compositions investigated are described in Table 1, below. Note that some samples were only mixed and melted. For those samples, an improvement in appearance is expected as the growth procedure is optimized. The results are shown in FIGS. 8-16.

TABLE 1
Zn containing scintillators investigated for this work.

| Precursor | | | |
|---|---|---|---|
| materials | Composition | Dopant | Synthesis type |
| 2CsCl + ZnCl₂ | Cs₂ZnCl₄ | Eu 0.5% | Vertical Bridgman |
| 2CsBr + ZnBr₂ | Cs₂ZnBr₄ | Eu 0.5% | Vertical Bridgman |
| 2CsI + ZnBr₂ | Cs₂ZnBr₂I₂ | Eu 0.5% | Vertical Bridgman |
| 2CsBr + ZnI₂ | Cs₂ZnI₄ | Eu 0.5% | Vertical Bridgman |
| 2LiI + ZnI₂ | Li₂ZnI₄ | Eu 0.5% | Melt only |
| 3CsCl + ZnCl₂ | Cs₃ZnCl₅ | Eu 0.5% | Vertical Bridgman |
| 3CsBr + ZnBr₂ | Cs₃ZnBr₅ | Undoped | Vertical Bridgman |
| 3CsBr + ZnBr₂ | Cs₃ZnBr₅ | Eu 0.5% | Vertical Bridgman |
| 3CsI + ZnBr₂ | Cs₃ZnBr₂I₃ | Eu 0.5% | Melt only |
| 2CsI + ZnI₂ | Cs₃ZnI₅ | Undoped | Vertical Bridgman |
| 3CsI + ZnI₂ | Cs₃ZnI₅ | Eu 0.5% | Melt only |
| 3CsI + ZnI₂ | Cs₃ZnI₅ | Cu 0.5% | Melt only |
| 3LiI + ZnI₂ | Li₃ZnI₅ | Eu 0.5% | Melt only |
| CsI + 2ZnI₂ | CsZn₂I₅ | Eu 0.5% | Melt only |

In addition to the scintillators described in Table 1, Cs₂ZnI₄ doped with 1% Y, 1% Hf, Tl, In, and Yb were prepared.

Crystal Growth of TlZn₂Cl₅ and Tl₂ZnCl₄

The crystal growth of the cesium/thallium zinc halides (e.g., TlZn₂Cl₅ and Tl₂ZnCl₄) was performed by loading anhydrous beads of cesium halide or thallium halide, together with the zinc halide in the appropriate stoichiometric ratio in quartz ampoules which were subsequently sealed under reduced pressure. Crystals were typically grown at a rate of 0.2-1 mm/hour from the top to the bottom in the gradient of the Bridgman furnace. After the crystal growth was finished, the furnace was cooled to room temperature at a rate of 10° C./hour. Crystals thus obtained were typically 1 cm³ or smaller. The crystals are extremely clear but show some cracks due to sticking to the ampoule. Tl₂ZnCl₄ has the orthorhombic crystal structure, space group no. 62 (Pnma). Based on structure and lattice parameters, the calculated density of Tl₂ZnCl₄ is 4.98 g/cm³.

Neutron Detection with (Cs,Li)₃Cu₂I₅:Tl

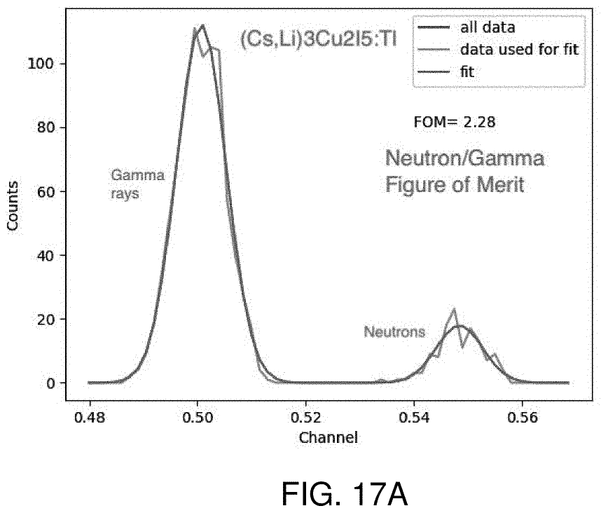

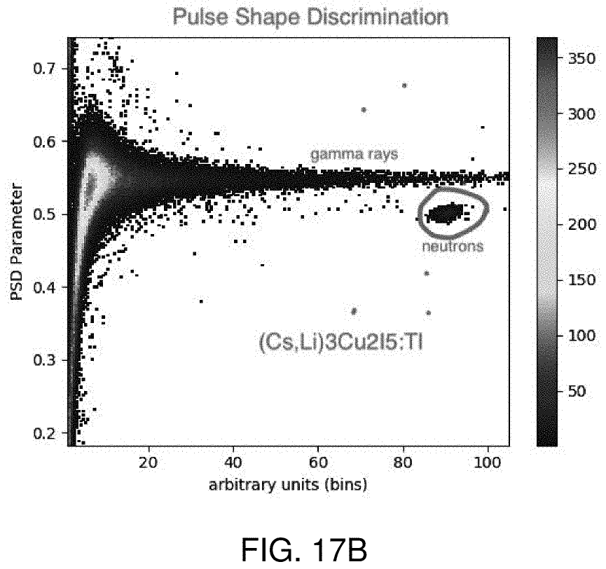

A Cs₃Cu₂I₅:Tl crystal in which a fraction of the Cs has been replaced with ⁶Li or a combination of ⁶Li+⁷Li, i.e. natural Li, is optically coupled to a photomultiplier tube to make a detector. A ²⁵²Cf source, moderated with paraffin or other hydrogenous material to produce thermal neutrons, is located near the detector. Thermal neutrons from the source interact with ⁶Li in the crystal to produce energetic alpha particles (⁴He) and tritons (³H) that induce a strong scintillation response from the crystal due to the combined kinetic energy of ˜4.8 MeV of the alpha and triton. The scintillation signal arising from the thermal neutron reaction can be distinguished from gamma-ray events of similar energy via a difference in the pulse shapes known as the “pulse shape discrimination or PSD” technique. Data is shown in FIGS. 17A and 17B.

Incorporation of ¹⁰B or natural B (¹⁰B+^{11B}) in the crystal could also be used to detect thermal neutrons via the resulting energetic alpha particles and recoiling ⁷Li ions.

Reactions:

⁶Li(n,α)t

¹⁰B(n,α)⁷Li

Crystal Growth and Characterization of Cu-Containing Halides

Single crystals were grown of undoped Cs₃Cu₂I₅ and Cs₃Cu₂I₅ doped with varying dopant types (e.g., Tl⁺) and concentrations.

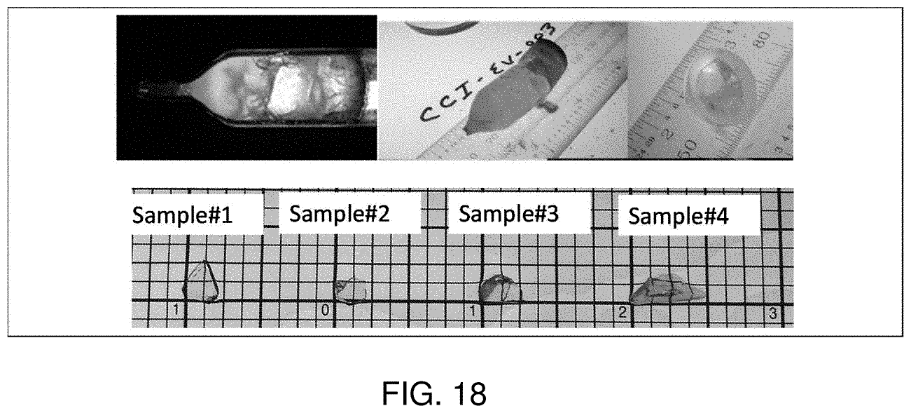

FIG. 18 shows an excellent quality 16 mm diameter single crystals of Tl-doped Cs₃Cu₂I₅.

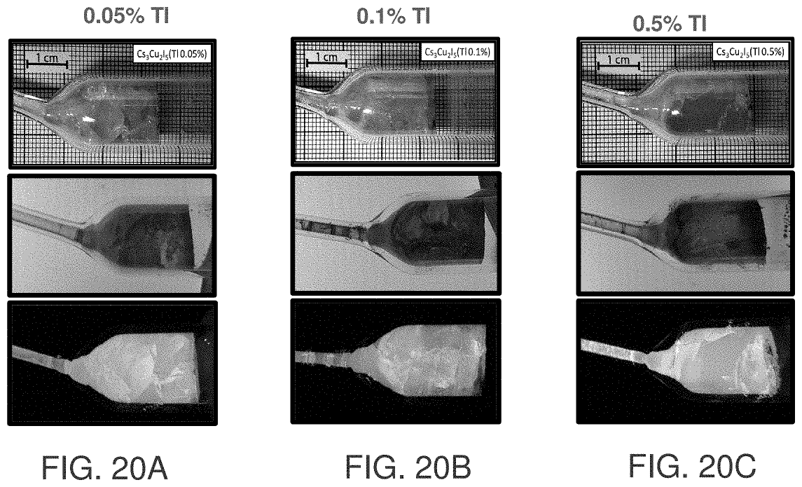

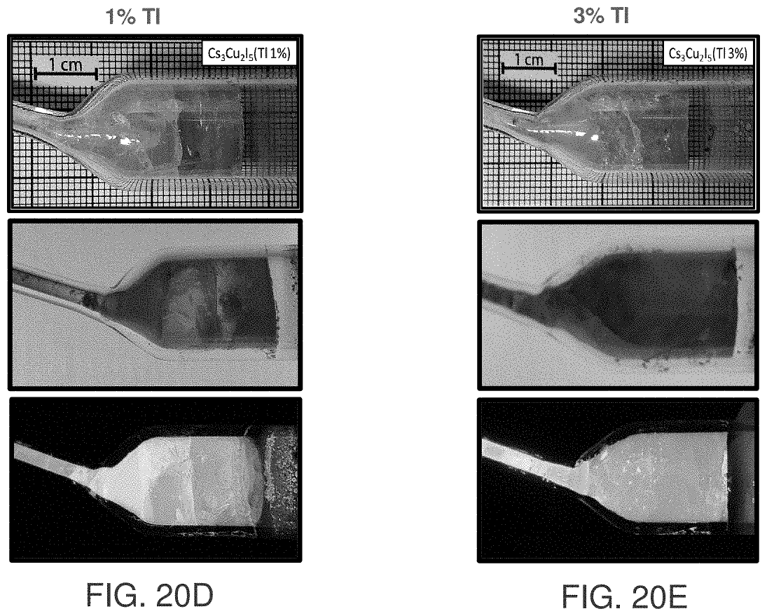

FIGS. 20A-20E show excellent quality single crystals of Cs₃Cu₂I₅: 0.05% Tl (FIG. 20A); Cs₃Cu₂I₅: 0.1% Tl (FIG. 20B); Cs₃Cu₂I₅: 0.5% Tl (FIG. 20C); Cs₃Cu₂I₅: 0.1% Tl (FIG. 20D); Cs₃Cu₂I₅: 3% Tl (FIG. 20E)

FIG. 23 shows an excellent quality 1 inch diameter single crystal of undoped Cs₃Cu₂I₅.

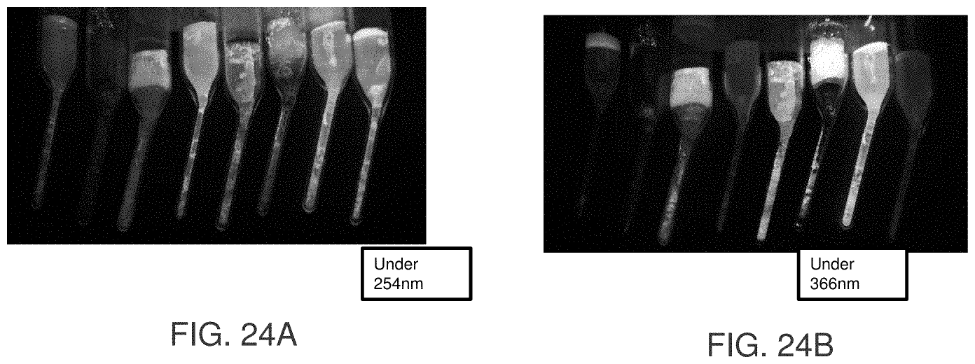

FIGS. 24A-24B show excellent quality (crack free) co-doped Cs₃Cu₂I₅ crystals: from left to right: Cs₃Cu₂I₅(Y 0.5%), Cs₃Cu₂I₅(In 2%), Cs₃Cu₂I₅(Ce 2%), Cs₃Cu₂I₅(Sr 1%), Cs₃Cu₂I₅(Yb 1%), Cs₃Cu₂I₅(Hf 1%), Cs₃Cu₂I₅(Eu 2%) Cs₃Cu₂I₅(Ce 2%), Cs₃Cu₂I₅(Ca 0.5%).

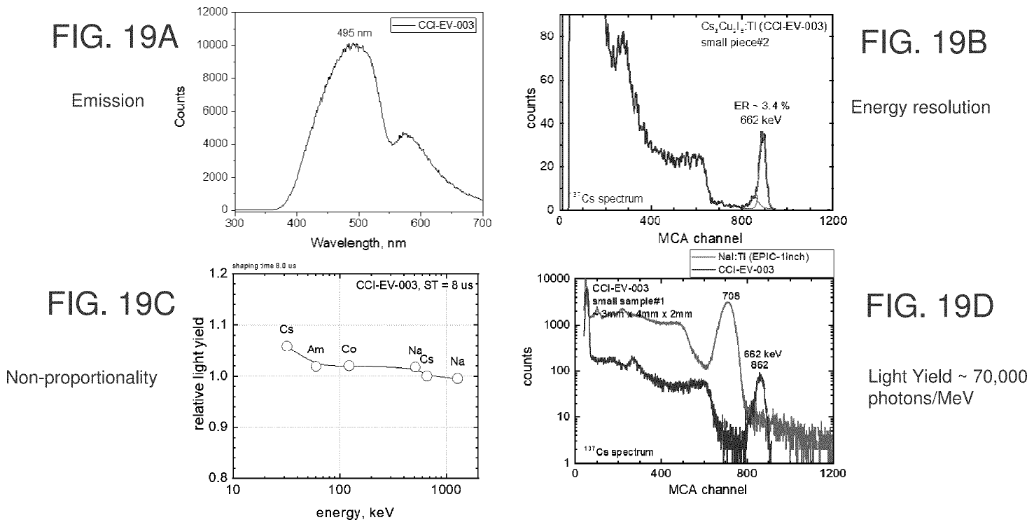

Certain scintillator samples were further characterized to measure scintillation properties of Cs₃Cu₂I₅: 0.2% Tl: Emission (FIG. 19A); Energy Resolution (FIG. 19B); Non-proportionality (FIG. 19C); and Light Yield (FIG. 19D).

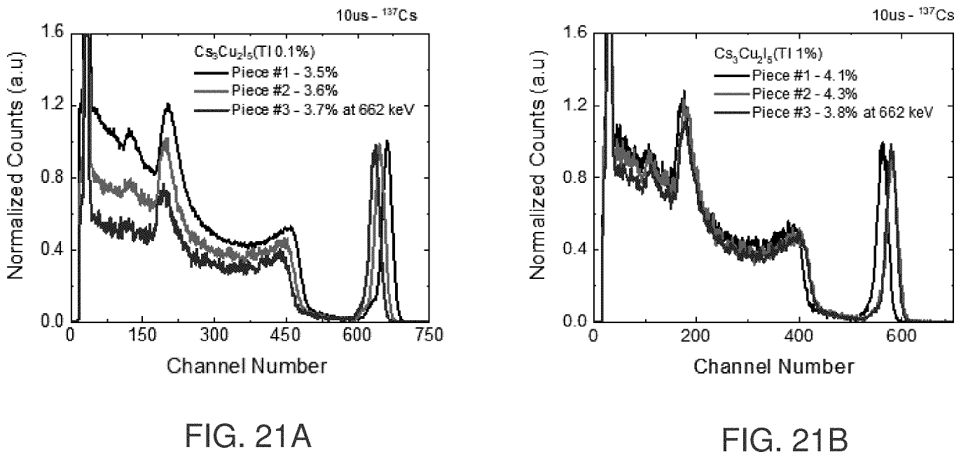

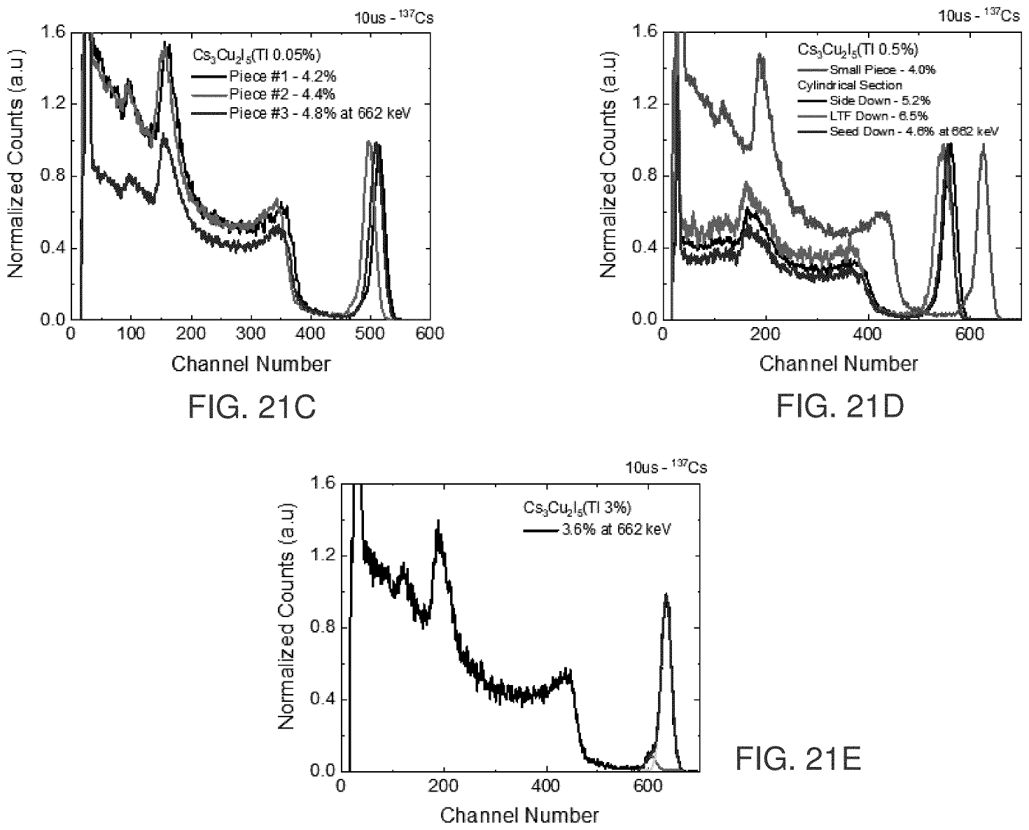

FIGS. 21A-21E show the gamma response of Cs₃Cu₂I₅: 0.1% Tl (FIG. 21A); Cs₃Cu₂I₅: 1% Tl (FIG. 21B); Cs₃Cu₂I₅: 0.05% Tl (FIG. 21C); Cs₃Cu₂I₅: 0.5% Tl (FIG. 21D); Cs₃Cu₂I₅: 3% Tl (FIG. 21E).

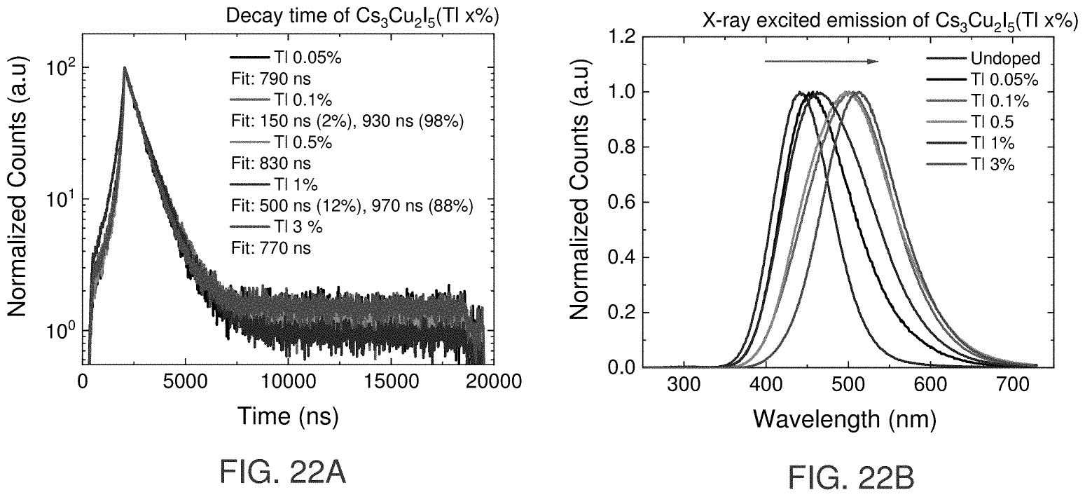

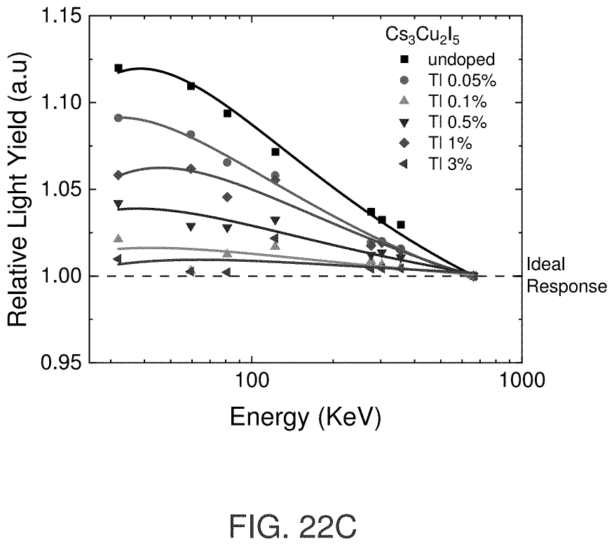

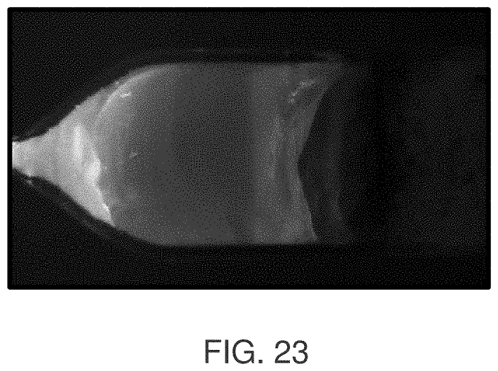

FIGS. 22A-22C show the scintillation properties of Cs₃Cu₂I₅: X % Tl including Decay time (FIG. 22A); X-ray excited emission (FIG. 22B); Non-proportionality (FIG. 22C)

It will be understood that various details of the presently disclosed subject matter may be changed without departing from the scope of the presently disclosed subject matter. Furthermore, the foregoing description is for the purpose of illustration only, and not for the purpose of limitation.

What is claimed is:

1. A scintillator material comprising a composition of one of Formulas (I)-(VII):
A₂MX₃; (I)
AM₂X₃; (II)
A₃M₂X₅; (III)
A₂M′X₄; (IV)
A₃M′X₅; (V)
AM₂X₅; or (VI)
A_{1-y}M_{y}X; (VII)
wherein:
y is an integer between 0.0001 and 0.9999;
A is one or more elements selected from the group comprising Li, Na, Rb, B, Cs, and Tl;
M is Cu, Ag, or a combination thereof;
M′ is one or more elements selected from the group comprising Zn, Hg, Cu, and Cd; and
X is one or more halogen; and
wherein 0 mole percent (mol %) to 100 mol % of A and/or M or M′ can be replaced by L, wherein L is an isovalent or aliovalent luminescent ion of an element selected from Au, Cu, Tl, In, Sn, Yb, Eu, Ce, and Pr or a combination thereof.

2. The scintillator material of claim 1, wherein A comprises Cs, M comprises Cu and X comprises I.

3. The scintillator material of claim 2, comprising Cs₃Cu₂I₅ and optionally a dopant.

4. The scintillator material of claim 1, wherein at least one of A and M or M′ is at least partially replaced by L.

5. The scintillator material of claim 4, wherein 0.5 mol % of one of A and M or M′ is replaced by L.

6. The scintillator material of claim 1, wherein the scintillator material comprises a single crystal having a composition of one of Formulas (I)-(VII).

7. The scintillator material of claim 1, wherein the material is not Cs₃Cu₂[I₁₋ₓClₓ]₅, wherein 0.71≤x≤0.79.

8. The scintillator material of claim 1, wherein when the scintillator material comprises a composition of Formula (III) and M is Cu and A comprises Cs, A further comprises Li, B, or Na, and when the scintillator material is a composition of Formula (II) the scintillator material has a composition that is other than CsCu₂I₃.

9. The scintillator material of claim 1, wherein the scintillator material comprises a composition of Formula (III) and wherein A is a mixture of Cs and Li, wherein the Li comprises or consists of ⁶Li.

10. The scintillator material of claim 9, wherein the scintillator material comprises (Cs₁₋ₓLiₓ)₃Cu₂I₅:Tl

11. The scintillator material of claim 1, wherein the scintillator material has a composition of one of Formulas (IV), (V), and (VI), wherein A comprises Cs and M′ comprises Zn.

12. The scintillator material of claim 1, wherein the scintillator material is selected from the group comprising Cs₂ZnCl₄, 0.5 mol % Eu; Cs₂ZnBr₄, 0.5 mol % Eu; Cs₂ZnBr₂I₂, 0.5 mol % Eu; Cs₂ZnI₄, 0.5 mol % Eu; Li₂ZnI₄, 0.5 mol % Eu; Cs₃ZnCl₅, 0.5 mol % Eu; Cs₃ZnBr₅; Cs₃ZnBr₅, 0.5 mol % Eu; Cs₃ZnBr₂I₃, 0.5 mol % Eu; Cs₃ZnI₅; Cs₃ZnI₅, 0.5 mol % Eu; Cs₃ZnI₅, 0.5 mole % Cu; Li₃ZnI₅, 0.5 mol % Eu; and CsZn₂I₅, 0.5 mol % Eu.

13. The scintillator material of claim 1, wherein the scintillator material is Cs₂ZnI₄ wherein L is present and wherein L is selected from Eu, Tl, In, and Yb.

14. The scintillator material of claim 1, wherein when L is not present, the scintillator material has a composition other than CsCu₂I₃, Cs₂ZnI₄ or Cs₃ZnBr₅.

15. A radiation detector comprising a scintillator material of claim 1 and a photon detector.

16. A method of detecting gamma rays, X-rays, cosmic rays, and/or particles having an energy of 1 keV or greater, the method comprising using the radiation detector of claim 13.

17. A method of detecting neutrons, the method comprising using the radiation detector comprising a photon detector and a scintillator material of claim 1, wherein A comprises Li or B, optionally wherein the method of detecting neutrons comprises detecting thermal neutrons.

18. A composition comprising Cs₂ZnI₄, 1 mole % Y or Cs₂ZnI₄, 1 mole % Hf.

19. A scintillator material comprising a composition of one of Formulas (I)-(VII):
A₂MX₃; (I)
AM₂X₃; (II)
A₃M₂X₅; (III)
A₂M′X₄; (IV)
A₃M X₅; (V)
AM₂X₅; or (VI)
A_{1-y}M_{y}X; (VII)
wherein:
y is an integer between 0.0001 and 0.9999;
A is one or more elements selected from the group comprising Li, Na, Rb, B, Cs, and Tl;
M is Cu, Ag, or a combination thereof;
M′ is one or more elements selected from the group comprising Zn, Hg, Cu, and Cd; and
X is one or more halogen; and
wherein 0.0001 mole percent (mol %) to 100 mol % of A and/or M or M′ is replaced by L, wherein L is an isovalent or aliovalent luminescent ion of an element selected from Au, Cu, Tl, In, Sn, Yb, Eu, Ce, and Pr or a combination thereof, and
wherein when the scintillator material comprises a composition of Formula (III) and M is Cu and A comprises Cs, A further comprises Li, B, or Na; and wherein when the scintillator material is a composition of Formula (II), the scintillator material has a composition that is other than CsCu₂I₃.

20. The scintillator material of claim 19, wherein the scintillator material comprises a single crystal having a composition of one of Formulas (I)-(VII).
